(19) United States
(12) Patent Application Publication
(10) Pub. No.: US 2013/0114076 A1
(43) Pub. Date: May 9, 2013

(54) CARTRIDGE WITH LARGE-SCALE MANUFACTURING DESIGN

(71) Applicants: Johannes Joseph Hubertina Barbara Schleipen, Eindhoven (NL); Albert Hendrik Jan Immink, Eindhoven (NL); Menno William Jose Prins, Eindhoven (NL); Derk Jan Wilfred Klunder, Eindhoven (NL)

(72) Inventors: Johannes Joseph Hubertina Barbara Schleipen, Eindhoven (NL); Albert Hendrik Jan Immink, Eindhoven (NL); Menno William Jose Prins, Eindhoven (NL); Derk Jan Wilfred Klunder, Eindhoven (NL)

(73) Assignee: KONINKLIJKE PHILIPS ELECTRONICS N.V., EINDHOVEN (NL)

(21) Appl. No.: 13/809,304

(22) PCT Filed: Jul. 5, 2011
(86) PCT No.: PCT/IB11/52960

§ 371 Date: Jan. 9, 2013

(30) Foreign Application Priority Data
Jul. 9, 2010 (EP) 10169065.9

(51) Int. Cl. G01N 21/01

(52) U.S. Cl. CPC G01N 21/01
USPC 356/246

(57) ABSTRACT

The invention relates to a cartridge (110) and an examination apparatus (100) for optical examinations of a sample. The cartridge (110) comprises a transparent bottom layer (113) that is of substantially uniform thickness and a top layer (111, 112) comprising a sample chamber (SC). The bottom layer and the top layer are preferably laminated onto each other, for example in a C roll-to-roll process. The bottom layer (113) is provided with structures like gratings (115) that allow the incoupling or outcoupling of light.

### FIELD OF THE INVENTION

The invention relates to a cartridge for optical examinations of a sample, to an examination apparatus in which such cartridge can be used, and to a method for the production of such a cartridge.

### BACKGROUND OF THE INVENTION

From the WO 2008/155716 A1 a biosensor is known in which target components labeled with magnetic beads are detected by frustrated total internal reflection (FTIR) at the sensing surface of a cartridge. To ensure the proper optical geometry of the input light beam and the output light beam, the cartridge comprises particular entrance and exit windows that protrude from the bottom side of the cartridge and are slanted with respect to the detection plane. A cartridge with such a structure can for example be manufactured by injection moulding.

### SUMMARY OF THE INVENTION

Based on this background it was an object of the present invention to provide means for optical examinations of a sample that allow for a cost-effective mass production, particularly with respect to disposable components.

This object is achieved by a cartridge according to claim 1, a method according to claim 11, an examination apparatus according to claim 12. Preferred embodiments are disclosed in the dependent claims.

According to its first aspect, the invention relates to a cartridge for optical examinations of a sample, wherein the term “cartridge” shall in general denote an exchangeable element or unit that can accommodate a sample during its examination in an examination device. The cartridge will usually be a disposable component which is used only once for a single sample. The sample may typically be a biological fluid, for example saliva or blood. The cartridge according to the invention comprises the following components:

a) A transparent “bottom layer” that is substantially of uniform thickness (i.e. the variation of its thickness is less than about 10%, preferably less than about 5%, most preferably less than about 2%) and that comprises a structure for the incoupling or outcoupling of light. In general, the bottom layer may have an arbitrary (e.g. bent) three-dimensional form. Most preferably, the bottom layer is however planar. The structure for the incoupling or outcoupling of light shall be such that it does not substantially affect the uniformity of the thickness of the bottom layer. The transparency of the bottom layer relates to the spectral range in which the optical examinations shall take place. This is typically the range of visible light together with the adjacent ranges of IR and UV light. It should be noted that the bottom layer may be uniform or consist of a plurality of sub-layers.

b) At least one “top layer” that is disposed above the aforementioned bottom layer and that comprises a sample chamber in which the sample can be provided. The sample chamber is typically an empty cavity or a cavity filled with some substance like a gel that may absorb a sample substance; it may be an open cavity, a closed cavity, or a cavity connected to other cavities by fluid connection channels. The bottom layer and the top layer may be made in one piece from the same material. Preferably, they are however two initially separate components that are attached to each other, for example by material bonding. Similar to the bottom layer, also the top layer preferably has a substantially uniform thickness (wherein internal cavities like the sample chamber are included when the thickness is measured). Moreover, the top layer may be uniform or preferably consist of a plurality of sub-layers (one of these sub-layers may for example be a double-adhesive tape, cut in the right form-factor to provide sample chambers and channels).

By using a transparent bottom layer, a cartridge is achieved that allows for making optical examinations within the sample chamber through the bottom layer. Due to its substantially uniform thickness, the bottom layer can cost-effectively be produced. This is extremely important as the cartridge comes into contact with the sample and is therefore typically a disposable device used only once. Hence it is an article of mass production, and any facilitation of the manufacturing process can yield considerable savings. The bottom layer and/or the top layer of the cartridge may preferably be made from a flexible sheet, particularly a foil. In this case the cartridge can favorably be produced in a process using large supplies of said flexible material, for example rolls of foil.

The bottom layer of the cartridge may preferably comprise a “light-input structure” for coupling an input light beam into the cartridge and for directing it (at least partially) to the sample chamber. With the light-input structure, losses occurring during the entrance of the input light beam due to reflection, scattering or the like can be reduced.

Additionally or alternatively, the bottom layer may comprise a “light-output structure” for coupling an output light beam out of the cartridge, wherein said output light beam comes from the sample chamber.

The above-mentioned light input and light-output structures facilitate and enhance the exchange of light with the cartridge. They may be realized in a variety of a ways, provided that these realizations do not affect the substantially uniform thickness of the bottom layer. The light-input structure and/or the light-output structure may particularly comprise a grating, a prismatic structure, or a smoothened side window. With the exception of the side window, the enumerated structures are typically provided in the (bottom) main face of the bottom layer.

The light that propagates through the cartridge and in particular through its bottom layer is intended to interact with a sample in the sample chamber. To this end, the light must at least temporarily enter the sample chamber. This may for example be achieved by evanescent waves generated during the total internal reflection of an input light beam at the interface of the sample chamber. In a preferred embodiment, the light-input structure is therefore designed such that at least a part of the input light passing through this structure is (after its further propagation through the bottom layer) totally internally reflected at the interface to the sample chamber. In a related preferred embodiment, the light-output structure is designed such that at least a part of the light passing through this structure originates from a total internal reflection at the interface to the sample chamber. It should be noted that, if reference is made to “total internal reflection”, the medium in the sample chamber is considered to be given in advance; in particular, this medium may have a refractive index between about 1.2 and about 1.5, preferably between about 1.33 and 1.35.

According to a further development of the aforementioned embodiment, the mentioned part of the light (i.e. the part that passes through the light-input or light-output structure and is/was totally internally reflected at the interface to the sample chamber) is comprised by the first diffractive order generated by the light-input structure or the light-output structure. Most preferably, only diffraction of zero and first order are generated by the light-input or light-output structure. Using the first order diffraction has the advantage that it comprises a high amount of light and that it allows for a deflection of a light beam. When a diffraction grating is used, it is preferably designed such that e.g. the intensity in the +1st order is maximized, or the intensity in the 0th order is strongly suppressed.

According to another embodiment, the bottom layer comprises an optical structure at the interface to the sample chamber for coupling light into the sample chamber (by refraction) and/or for collecting light from the sample chamber. Optical structures that are suited for this purpose comprise for example a plurality of grooves of triangular cross section. Such structures are described in the WO 2009/125339 A2, which is incorporated into the present text by reference.

The cartridge may particularly comprise at least two layers of different refractive indices, wherein said layers may for example constitute the transparent bottom layer. With the help of such layers, wave guiding properties can be realized.

According to another embodiment, the cartridge comprises at least one mirroring coating, wherein said coating may be provided on an outer surface and/or on an inner interface between different layers, for example between the bottom layer and the top layer. Such a mirroring coating can be used to guide light parallel to the extension of the cartridge while preventing its transition into adjacent layers.

The invention further relates to a method for the production of a cartridge of the kind described above, said method comprising the lamination of a bottom layer and a top layer onto each other. Optional structures of the bottom layer or the top layer, for example cavities for the sample chamber in the top layer or grating structures in the bottom layer, may be produced before, during, or after the lamination. The lamination can particularly be achieved in a roll-to-roll process that allows mass production with a high throughput at moderate cost. Furthermore, the products generated by such a process are very uniform as they all have experienced the same manufacturing steps with little or no variation.

The produced cartridge is preferably pre-filled with reagents, particularly dry reagents. The cartridge is then ready to use when leaving the factory, and only a sample has to be added for making desired examinations. The reagents may for example comprise binding sites on a surface of the sample chamber to which target components of a sample can specifically bind and/or labels, for example superparamagnetic beads, that specifically bind to target components of a sample.

The invention further relates to an examination apparatus for optical examinations of a sample in a cartridge of the kind described above, said apparatus comprising the following components:

a) A seat for holding said cartridge.

b) A light source for generating an input light beam and for coupling this into the cartridge when the latter is accommodated in the seat. The light source may for example be a laser or a light emitting diode (LED), optionally provided with some optics for shaping and directing the input light beam.

c) A light detector for detecting an output light beam coming from the cartridge in the seat. The light detector may comprise any suitable sensor or plurality of sensors by which light of a given spectrum can be detected, for example photodiodes, photo resistors, photocells, a CCD chip, or a photo multiplier tube; the light detector typically also comprises the optical components (like lenses, mirrors, gratings) required to direct the light towards the respective sensor surface.

The cartridge may optionally be considered as a component of the examination apparatus or as a separate component of its own.

According to a further development of the examination apparatus, the light source comprises optics for directing the input light beam onto a side wall of the cartridge. As said side wall is usually small, the corresponding optics will typically comprise means for concentrating the input light beam to a small area. Moreover, the optics is preferably designed such that the coupled-in input light beam (or at least a large part of it) reaches the interface between the bottom layer and the sample chamber at an angle of total internal reflection.

In another embodiment, the examination apparatus comprises a prismatic structure adapted to come into contact with the cartridge. Thus a good optical contact between the cartridge and the light source can be made which allows the transition of light with high efficiency. Preferably, an index matching oil may additionally be used in this case.

The examination apparatus may further comprise a magnetic field generator for generating a magnetic field inside the sample chamber. The magnetic field generator may for example comprise at least one permanent magnet or electromagnet. With the magnetic field in the sample chamber it is particularly possible to affect magnetic particles used as labels for target components. Hence binding processes can be accelerated and/or washing (i.e. removing unbound labels from the detection area) steps can be realized.

The invention further relates to the use of a cartridge or an examination apparatus of the kind described above for molecular diagnostics, biological sample analysis, chemical sample analysis, food analysis, and/or forensic analysis. Molecular diagnostics may for example be accomplished with the help of magnetic beads or fluorescent particles that are directly or indirectly attached to target molecules.

### BRIEF DESCRIPTION OF THE DRAWINGS

These and other aspects of the invention will be apparent from and elucidated with reference to the embodiment(s) described hereinafter. These embodiments will be described by way of example with the help of the accompanying drawings in which:

FIG. 1 schematically shows a side view of an examination apparatus according to the present invention;

FIG. 2 illustrates the entrance of an input light beam at a grating on the bottom surface;

FIG. 3 shows a diagram with the range of suitable grating periods A as a function of the ratio between the refractive indices n_{f} of the bottom layer and nₛ of the sample fluid;

FIG. 4 illustrates the entrance of an input light beam through a side wall;

FIG. 5 illustrates the bright field detection of an output light beam using gratings for the input and output of light;

FIG. 6 illustrates the detection of an output light beam through the side face of the cartridge.

Like reference numbers or numbers differing by integer multiples of 100 refer in the Figures to identical or similar components.

### DESCRIPTION OF PREFERRED EMBODIMENTS

Disposable cartridges as they are for example used in an optical biosensor according to the WO 2008/155716 A1 are typically produced from injection molded components, namely an “optical part” serving as the bottom and a “fluidic part” comprising necessary fluidic channels and chambers. The optical part usually has a complicated three-dimensional structure with prominent entrance and exit windows having high quality surfaces. Due to these complications, the mentioned parts contribute considerably to the costs of production. It is therefore desirable to provide means for optical examinations of a sample that can be realized in a more cost-effective mass production.

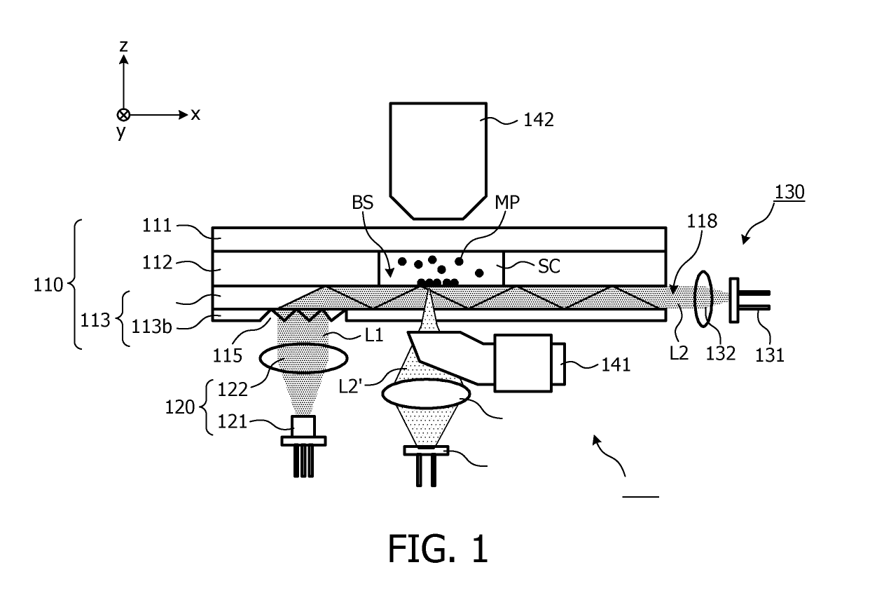

FIG. 1 schematically shows in a side view an examination apparatus 100 that realizes a solution to the aforementioned demands. The examination apparatus 100 comprises a light source 120 for emitting an “input light beam” L1 and light detectors 130, 130′ for detecting and measuring “output light beams” L2, L2′. The input light beam L1 is emitted into a (disposable) cartridge 110 that is accommodated in a seat of the examination apparatus and that may for example be made from transparent plastic like poly-styrene. The cartridge 110 comprises a sample chamber SC in which a sample fluid with target components to be detected (e.g. drugs, antibodies, DNA, etc.) can be provided. The sample further comprises magnetic particles MP, for example superparamagnetic beads, wherein these particles MP are usually bound as labels to the aforementioned target components (for simplicity only the magnetic particles MP are shown in the Figures). It should be noted that instead of magnetic particles other label particles, for example electrically charged of fluorescent particles, could be used as well.

The cartridge 110 has a particular layered design and a substantially uniform thickness (in z-direction). It consists of two principal (multi-) layers, namely:
A “bottom layer” 113, which consists in this example of a “core layer 113a” with high refractive index and a “cladding layer” 113b with low refractive index (the cladding layer is usually dispensable, because the interface of the core layer 113a to air may act as total internal reflection layer). The outer layer 113b may additionally or alternatively function as a protective coating.
A “top layer”, which consists in this example of an inner layer 112 with low refractive index and a cover layer 111.

Due to the substantially uniform thickness of the bottom layer and top layer, they can cost-effectively be produced, for example by laminating them onto each other in a roll-to-roll process. Materials that can be used as foils for the bottom layer (particularly the core layer 113a) are Polycarbonate or Polystyrene, which have typical refractive indexes between 1.55 and 1.6. In order to have an as low as possible decay length of the evanescent field for a given angle of incidence, it is preferable to have an as high as possible refractive index of the bottom foil 113. Thickness of the bottom foil 113 is typically between 100-500 microns, preferably 200-500 microns (to ensure mechanical stability).

The top layer(s) 111, 112 are preferably also a foil, as this opens the potential to process the cartridge 110 in a roll-to-roll manner. However, a rigid part might also be acceptable as there is no need for optical quality and injection molding. The material of the top part can optionally be of same material as the bottom foil (but this needs not be the case). Dry reagents are preferably arranged in the top layer part, but there is some freedom to deposit them elsewhere.

The interface between the bottom layer 113 and the sample chamber SC is formed by a surface called “binding surface” BS. This binding surface may optionally be coated with capture elements, e.g. antibodies, which can specifically bind the target components. At the optical inspection area (size typical 1 mm²), the cartridge should have optical properties, i.e. thickness variations less than typically λ/4 are required.

The examination apparatus 100 optionally comprises a magnetic field generator, for example electromagnets 141 and 142 with a coil and a core, for controllably generating a magnetic field at the binding surface and in the adjacent space of the sample chamber SC. With the help of this magnetic field, the magnetic particles MP can be manipulated, i.e. be magnetized and particularly be moved (if magnetic fields with gradients are used). Thus it is for example possible to attract magnetic particles to the binding surface in order to accelerate the binding of the associated target component to said surface.

The light source 120 comprises a laser or an LED 121, e.g. a red 650 nm LED, that generates the input light beam L1 which is transmitted via a lens 122 onto a grating 115 in the cladding layer 113b (the grating structure may also be part of the core layer 113a, made for example by directly embossing into, or replication onto, the core layer). After passing through this grating 115, the input light beam L1 is (inter alia) diffracted sideward towards the sample chamber SC. It is guided parallel to the extension of the cartridge (i.e. in x-direction) through the core layer 113a, which constitutes in cooperation with the cladding layer 113b and the inner layer 112 a wave guide. The input light beam L1 is totally internally reflected at the binding surface of the sample chamber because it arrives there at an angle larger than the critical angle of total internal reflection (TIR).

When the input light beam L1 is total internally reflected, an evanescent wave penetrating (exponentially dropping in intensity with distance from cartridge) into the sample chamber SC. If this evanescent wave interacts with bound magnetic particles MP, part of the input light will be coupled into the sample fluid (this is called “frustrated total internal reflection”), and the reflected intensity will be reduced (while the reflected intensity will be 100% for a clean interface and no interaction). Further details of this procedure may be found in the WO 2008/155723 A1.

In the embodiment of FIG. 1, the detection of the output light beam L2 that comes from the binding surface BS is done by a light detector 130. This light detector 130 comprises a photodetector 131 with a corresponding lens 132 can are positioned at a side wall 118 of the cartridge 110. The photodetector 131 measures the output light beam L2 that is guided sideward through the core layer 113a.

Additionally or alternatively, the detection of bound magnetic particles may be done in dark field, i.e. by imaging the binding surface BS with the beads through the laminate layers 113a, 113b with a light detector 130′. This light detector 130′ comprises a photodetector or 2D-camera 131′ arranged behind a lens 132′. The output light beam L2′ collected by the light detector 130′ consists of light scattered by magnetic particles MP that are bound to the binding surface BS.

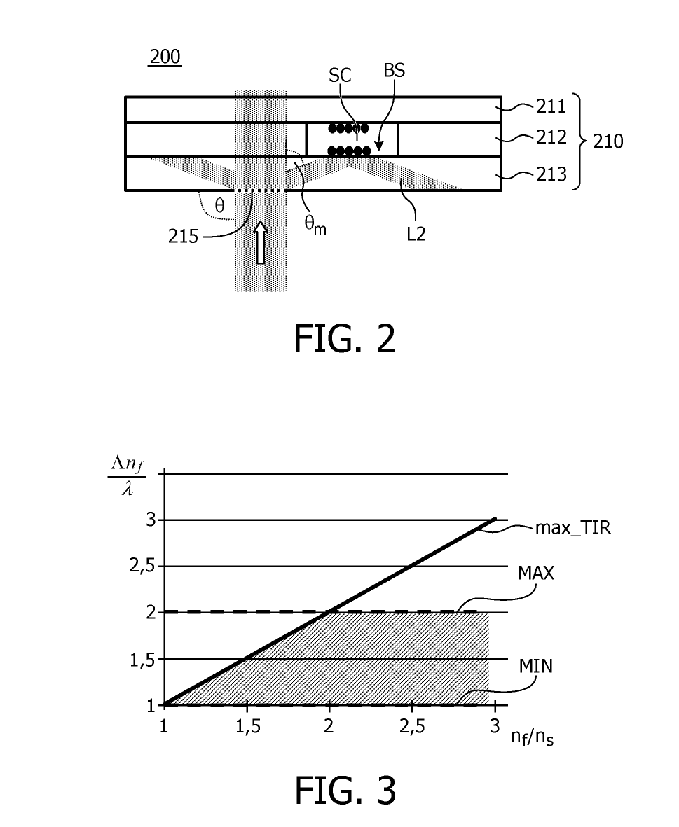

The described examination apparatus 100 has the following advantages:
It allows single bead detection leading to high performance (low analytical detection limits).
The flat design of the disposable cartridge 110 allows close proximity of magnet tips near to the sample chamber, potentially generating high fields and high field gradients (so high magnetic forces) in the reaction chamber.
The detection principle is still based on frustrated total internal reflection by bound magnetic nanoparticle labels. This method is well known and well characterized.
The configuration allows optical references to compensate for variations in incoupling efficiency and output of the light source.
The particular design shown in FIG. 1 can be varied in several ways while keeping the advantage of a low cost manufacturing of the cartridge. FIGS. 2 and 4 to 6 show in this respect different modifications/explanations that relate to the incoupling and outcoupling of an input light beam L1 and an output light beam L2, respectively. Though not shown in these Figures, the total internal reflected beam inside the bottom layer may undergo more than one total internal reflection before it leaves the cartridge (as in FIG. 1). In FIG. 2, an evanescent field excitation is achieved by coupling input light L1 into the cartridge 210 using a grating structure 215, embossed at the bottom side of the bottom layer 213. By proper design of the grating 215, (part of) the incoming light L1 will be diffracted towards the foil-liquid interface BS under an angle θₘ larger than the critical angle of total internal reflection (TIR), thereby creating an evanescent field at said interface BS.

It should be noted that “double refraction detection” (DRD) may be used (instead of evanescent fields generated by TIR) to create a surface-localized optical field. This approach requires that e.g. a wedge-like structure (not shown) is embossed in the bottom layer at the position of the binding surface BS of the cartridge. Details about this approach may be found in the WO 2009/125339 A2.

In the following derivation of appropriate design parameters for the grating 215, it is assumed that the incoming input light beam L1 is incident at the grating under an angle θ. The grating will diffract the incident light into discrete grating orders m with each order having a unique angle θₘ (unless stated otherwise, all angles are measured with respect to the normal of the bottom layer 213). The diffraction orders into the bottom layer are defined by:

$${n}_{f} sin ( {θ}_{m} ) = sin ( θ ) + \frac{λ m}{Λ} \qquad ( 1 )$$

with λbeing the wavelength in vacuum of the incident light, Λ the period of the grating, m the grating order, and n_{f} the index of refraction of the bottom layer 213.

Preferably, besides the fundamental grating order (m=0), only the first grating order (m=±1) propagates through the bottom layer. This requires that

$$\begin{matrix}\frac{1}{{n}_{f}} ( sin ( θ ) + \frac{λ m}{Λ} ) > 1 for \vert m \vert \geq 2 , \\ and & ( 2 a ) \\ \frac{1}{{n}_{f}} ( sin ( θ ) + \frac{λ m}{Λ} ) \leq 1 for \vert m \vert \leq 1. & ( 2 b )\end{matrix}$$

Assuming a normal incident beam (θ=0°), requirements (2a), (2b) lead to the following condition for the grating period Λ:

$$1 < \frac{Λ \cdot {n}_{f}}{λ} < 2. \qquad ( 3 )$$

Furthermore, total internal reflection at the sample interface requires (with nₛ being the refractive index of the sample):

$$\vert sin ( {θ}_{m = \pm 1} ) \vert > \frac{{n}_{s}}{{n}_{f}} \qquad ( 4 )$$

Inserting (4) into eq. (1) implies, for θ=0° and m=1:

$$\frac{Λ \cdot {n}_{f}}{λ} < \frac{{n}_{f}}{{n}_{s}} . \qquad ( 5 )$$

Combining relations (3) and (5) results in a range of suitable grating periods Λ for a given ratio between the index of refraction of the bottom layer, n_{f}, and the sample fluid, nₛ. This is illustrated in FIG. 3, which shows said range (cf. hatched area) as a function of the ratio n_{f}/nₛ (horizontal axis), which is larger than 1. Suitable grating periods are between the lower dashed line “MIN” and the slanted line “max TIR” as long as the max TIR curve is below the upper dashed curve “MAX”. For n_{f}/nₛ>2, the suitable grating periods Λ are between the MIN and the MAX lines.

The conclusions from relations (4) and (5) and FIG. 5 can be summarized in the following formula for the range of the normalized grating periods:

$$1 < \frac{Λ \cdot {n}_{f}}{λ} < Min \{ \frac{{n}_{f}}{{n}_{s}} , 2 \} \qquad ( 6 )$$

Assuming water as a sample fluid (nₛ=1.33) and a bottom layer (foil) with index of refraction n_{f}=1.56, and a wavelength λ of 650 nm, one finds 416-488 nm as the range of suitable grating periods Λ.

The fundamental diffraction order (m=0) of the normal incident light propagates through the bottom layer 213 and the top layer 211, 212 (with the sample chamber). The transmission in case no fluid (but air instead) is present in the sample chamber is different, and this way the presence of a fluid in the cartridge can be detected and can be used for timing of the assay or as a wetting detector.

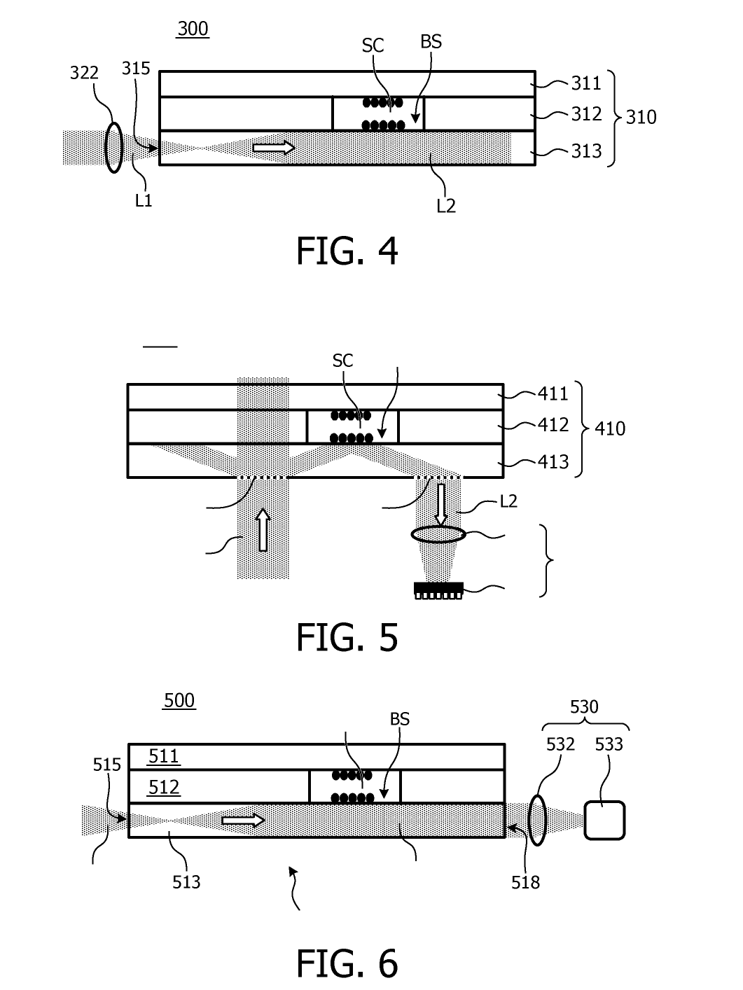

In FIG. 4, evanescent field excitation is achieved by coupling input light L1 into the cartridge 310 using sideways illumination of a side wall 315 by a low-NA coupling lens 322. The fraction of the light with an angle of incidence (with respect to the interface BS between bottom layer and sample chamber) above the critical angle of the interface BS travels in the bottom foil 313, acting as a waveguide, thereby creating an evanescent field at the interface BS to the sample chamber SC. The side wall 315 of the foil should have good optical properties (flatness) to achieve a satisfactory incoupling of the input light beam L1.

When the numerical aperture NA of the incoupling lens 322 shall be calculated, it has to be taken into account that total internal reflection at the interface BS between bottom foil and sample sets a minimum value for the angle of incidence with respect to this interface. Realizing that the maximum value of the angle of incidence is in good approximation determined by the NA of the in-coupling lens 322, one finds as an upper limit for the NA of the in-coupling lens:

NA²<n_{f}²−nₛ² (7)

Using the same parameters as above, one finds a numerical aperture NA smaller than 0.82. Preferably one would however want to use an in-coupling lens with a somewhat smaller NA, in order to limit the decay length of the evanescent waves. In case of in-coupling with a lens, as shown in FIG. 4, one actually excites an ensemble of rays propagating under different angles, with each angle corresponding to a different decay length. If one wants to limit the intensity decay length into the fluid to a given height h*, this requires an upper limit for the NA of the in-coupling lens according to:

$${( \frac{NA}{{n}_{f}} )}^{2} \leq 1 - {( \frac{{n}_{s}}{{n}_{f}} )}^{2} - {( \frac{λ}{4 π {h}^{*} {n}_{f}} )}^{2} \qquad ( 8 )$$

For a wavelength λ of 650 nm and a maximum intensity decay length h* of 100 nm, assuming the same parameters as above, one finds an upper limit for the NA of the in-coupling lens 322 of NA<0.40. For a maximum intensity decay length h* of 80 nm, 70 nm, and 65 nm, the upper limit values for the NA of the in-coupling lens are 0.32, 0.22, and 0.11, respectively.

In FIG. 5, bright field imaging of the excitation area BS (illuminated e.g. by evanescent waves or DRD) is applied using diffraction gratings 415, 418 embossed in the bottom layer 413 of the cartridge 410. Incoupling of the input light beam L1 is achieved as in FIG. 2 with a first grating 415, while outcoupling is done with a second grating 418. Using reciprocity arguments, one preferably (but not necessarily) uses the same grating parameters for the second out-coupling grating 418 as for the first in-coupling grating 415.

FIG. 6 illustrates an approach in which the light that is propagated through the waveguide structure of the bottom layer 513 is imaged by a lens 532 on a detector element 533. The detector element 533 measures the integrated value of the totally internally reflected light, that is not frustrated by the beads; i.e., one cannot distinguish between different angles of the measured light rays. Multiplexing (multiple spots) can still be achieved by having a 1D array extending into the plane normal to the drawing plane and a lens array and detector array also extending into this plane.

In summary, the present invention provides a disposable cartridge technology (and related read-out instrument technology) with the following advantages:
The technology of the disposable cartridge is suited for a low-cost roll-to-roll manufacturing process. A first advantage of a roll-to-roll fabrication process is that it leads to low fabrication costs per test when the tests are produced at high numbers. A second advantage is that process variations are reduced because each disposable device will experience exactly the same processing steps.
The disposable components have a very good reproducibility, ensured by a manufacturing strategy wherein all components experience the exact same processing steps.
The disposable components and the related read-out instrument are preferably compatible with related approaches, e.g. an FTIR system with injection-molded cartridge, or with systems that have single bead resolution.

Characteristic technical features of the proposed approach comprise:
A cartridge combining a grating incoupler and outcoupler with a detection by frustrated total internal reflection.
A low cost cartridge based on laminated foils that has light-input structures and light-output structures.
A cartridge that has an optical window on the side of the laminate to couple in light (e.g. via a tapered optical structure, or via a fiber or lens coupling), or an optical window that allows contact with a prismatic structure in the analyzer to couple in light, combined with an outcoupling window that allows light from the waveguiding layer to fall on a photo-detector to serve as an intensity reference (e.g. to detect the in-coupling efficiency or to detect the amount of light lost in the evanescent field due to scattering and absorption by bound beads).
A low cost cartridge as above that is suitable for a roll-to-roll manufacturing process.
A low cost cartridge that has layers of higher and lower refractive indices, where the optical function of the layers are combined with adhesive layers.
An analyzer that has the means to read-out the low-cost cartridge.
A read-out device that has means to couple light into a waveguide structure in a disposable cartridge. This can be:
An optical path that illuminates a grating structure.
A tapered optical part that guides light into the side of the waveguiding layer.
   A prismatic structure that makes good contact with an optical window in the disposable cartridge. Typically this however requires the use of index matching oil to get reproducible incoupling.
A read-out device that is suitable to image a relative large optical field of view onto a 2D detector array through a high refractive waveguiding layer (i.e. a lens with spherical aberration compensation tuned to the waveguideling layers).

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. A cartridge for optical examinations of a sample, comprising:
a) a transparent bottom layer that is of a thickness with a variation of less than about 10%;
b) at least one top layer that is disposed above the bottom layer and that comprises a sample chamber (SC) in which the sample can be provided;
wherein the bottom layer comprises a light-input structure for coupling an input light beam (L1) into the cartridge and for directing it to the sample chamber (SC)
said light-input structure being designed such that at least a part of the light passing through this structure is totally internally reflected at the interface to the sample chamber (SC).

2. The cartridge according to claim 1,
characterized in that the bottom layer and/or the top layer is made from a flexible sheet, particularly a foil.

3. (canceled)

4. The cartridge according to claim 1,
characterized in that the bottom layer comprises a light-output structure for coupling out an output light beam coming from the sample chamber.

5. The cartridge according to claim 1,
characterized in that the light-input structure comprises a grating, a prismatic structure, or a smoothened side window.

6. The cartridge according to claim 3,
characterized in that the light-output structure is designed such that at least a part of the light passing through this structure was totally internally reflected at the interface to the sample chamber.

7. The cartridge according to claim 6,
characterized in that said part of the light is comprised by the first diffractive order generated by the light-input structure or the light-output structure.

8. The cartridge according to claim 1,
characterized in that the bottom layer comprises an optical structure at the interface to the sample chamber for coupling light into the sample chamber and/or for collecting light from the sample chamber.

9. The cartridge according to claim 1,
characterized in that it comprises at least two layers of different refractive indices.

10. The cartridge according to claim 1,
characterized in that it comprises at least one mirroring coating.

11. A method for the production of a cartridge according to claim 1, comprising the lamination of the bottom layer and the top layer.

12. An examination apparatus for optical examinations of a sample in a cartridge comprising:
a) a seat holding a cartridge according to claim 1;
b) a light source for generating an input light beam and for coupling it into the cartridge;
c) a light detector for detecting an output light beam coming from the cartridge.

13. The examination apparatus according to claim 12,
characterized in that the light source comprises optics for directing the input light beam onto a side wall of the cartridge.

14. The examination apparatus according to claim 12,
characterized in that it comprises a prismatic structure adapted to come into contact with the cartridge.

15. The examination apparatus according to claim 12,
characterized in that it comprises a magnetic field generator a for generating a magnetic field in the sample chamber.

16. The cartridge according to claim 4, characterized in that the light out-put structure comprises a grating, a prismatic structure, or a smoothened side window.
